(19) United States
(12) Patent Application Publication
(10) Pub. No.: US 2020/0174102 A1
(43) Pub. Date: Jun. 4, 2020

(54) LARGE FIELD OF VIEW MEASUREMENT DEVICES FOR LIDAR

(71) Applicant: Seagate Technology LLC, Cupertino, CA (US)

(72) Inventors: Pierre Asselin, Richfield, MN (US); Martin Giles Blaber, Minneapolis, MN (US); Zoran Jandric, St. Louis Park, MN (US); Dan Mohr, Roseville, MN (US); Kevin A. Gomez, Eden Prairie, MN (US)

(21) Appl. No.: 16/206,776

(22) Filed: Nov. 30, 2018

(51) Int. Cl. G01S 7/481; G01S 17/89

(52) U.S. Cl. CPC G01S 7/4817; G01S 17/89; G01S 7/4813

(57) ABSTRACT

An apparatus includes a detector, a light source configured to emit light, a plurality of disks, and a focusing apparatus. Each disk includes a set of prisms, and each disk is independently rotatable, arranged to receive the emitted light directly or indirectly from the light source, and arranged to receive backscattered light from an object. The focusing apparatus is arranged to focus the backscattered light from the plurality of disks towards the detector.

### SUMMARY

In certain embodiments, an apparatus includes a detector, a light source configured to emit light, a plurality of disks, and a focusing apparatus. Each disk includes a set of prisms, and each disk is independently rotatable, arranged to receive the emitted light directly or indirectly from the light source, and arranged to receive backscattered light from an object. The focusing apparatus is arranged to focus the backscattered light from the plurality of disks towards the detector.

In certain embodiments, a method for generating a scanning light pattern is disclosed. The method includes rotating a first disk in a first direction at a first speed, rotating a second disk in a second direction at the first speed, rotating a third disk in the first direction at a second speed. The first disk includes prisms at a first prism angle, the second disk includes prisms at the first prism angle, and the third disk includes prisms with a second prism angle. The method includes directing light from a light source through the first disk, the second disk, and the third disk to generate the scanning light pattern.

In certain embodiments, a system for generating a scanning light pattern is disclosed. The system includes a first disk configured to rotate in a first direction at a first speed and including prisms with a first prism angle, a second disk configured to rotate in a second direction at the first speed and including prisms with the first prism angle, and a third disk configured to rotate in the first direction at a second speed and including prisms with a second prism angle. The system further includes a light source configured to emit light such that the emitted light passes through the first disk, the second disk, and the third disk.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a schematic, cut-away view of a measurement device, in accordance with certain embodiments of the present disclosure.

FIG. 2 shows a perspective view of a disk used in the measurement device of FIG. 1, in accordance with certain embodiments of the present disclosure.

FIGS. 3A and 3B show close-up, cut-away views of a portion of a disk used in the measurement device of FIG. 1, in accordance with certain embodiments of the present disclosure.

FIG. 4 shows a top view of a disk that can be used in the measurement device of FIG. 1, in accordance with certain embodiments of the present disclosure.

FIG. 5 shows a schematic, perspective view of the measurement device of FIG. 1 and an example light pattern generated by the measurement device, in accordance with certain embodiments of the present disclosure.

FIG. 6 shows a perspective view of a curved mirror used in the measurement device of FIG. 1, in accordance with certain embodiments of the present disclosure.

FIG. 7 shows a schematic, cut-away view of another measurement device, in accordance with certain embodiments of the present disclosure.

FIG. 8 shows a schematic, cut-away view of another measurement device, in accordance with certain embodiments of the present disclosure.

FIG. 9 shows a schematic, cut-away view of another measurement device, in accordance with certain embodiments of the present disclosure.

FIG. 10 shows a schematic, cut-away view of another measurement device, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Certain embodiments of the present disclosure relate to measurement devices and techniques, particularly, measurement devices and techniques for light detection and ranging, which is commonly referred to as LIDAR, LADAR, etc.

Current LIDAR devices typically use a series of spinning mirrors that steer many narrow light beams. These devices utilize a low numerical aperture, such that only a small amount of reflected light is received by detectors within the device. As a result, these devices require very sensitive detectors. Certain embodiments of the present disclosure are accordingly directed to devices and techniques for measurement systems, such as LIDAR systems, in which sensors with a broader range of sensitivities can be used while still achieving accurate measurements. Further, as will be described in more detail below, the disclosed measurement devices include optical elements and arrangements that can be used to generate scanning patterns of light (e.g., paths along which light is scanned) with a large field of view using as few as one light source and to detect backscattered light using as few as one detector.

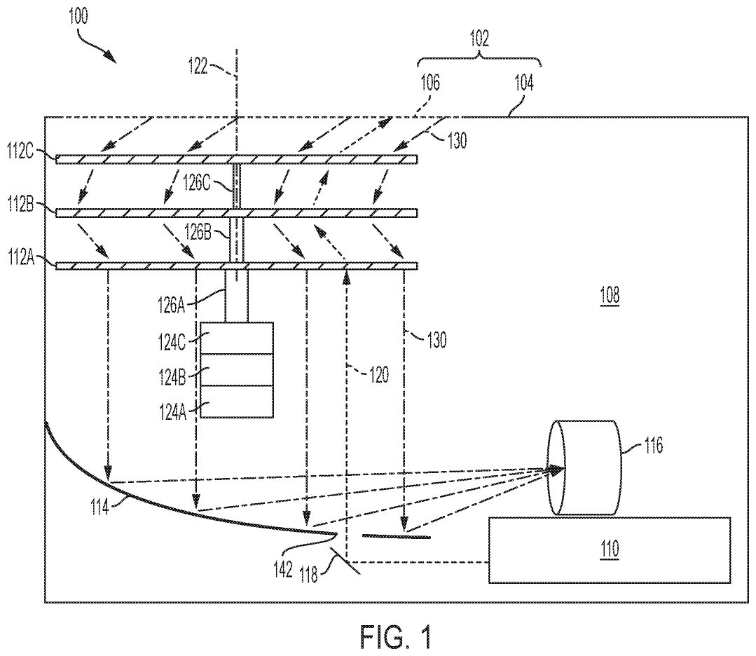

FIG. 1 shows a schematic of a measurement device 100 (e.g., a LIDAR/LADAR device) including a housing 102 with a base member 104 and a cover 106. The base member 104 and the cover 106 can be coupled together to surround an internal cavity 108 in which various components of the measurement device 100 are positioned. Various surfaces of components of the housing 102 can be coated with a light-absorbing or anti-reflective coating. In certain embodiments, the base member 104 and the cover 106 are coupled together to create an air and/or water-tight seal. For example, various gaskets or other types of sealing members can be used to help create such seals between components of the housing 102. The base member 104 can comprise materials such as plastics and/or metals (e.g., aluminum). The cover 106 can comprise transparent materials such as glass or sapphire. For simplicity, the housing 102 in FIG. 1 is shown with only the base member 104 and the cover 106, but the housing 102 can comprise any number of components that can be assembled together to surround the internal cavity 108 and secure components of the measurement device 100. Further, the base member 104 may be machined, molded, or otherwise shaped to support the components of the measurement device 100.

The measurement device 100 includes a light source 110, a plurality of disks (e.g., a first disk 112A, a second disk 112B, and a third disk 112C), a focusing apparatus 114, and a detector 116. In certain embodiments, the measurement device 100 also includes one or more reflectors 118. The features of the measurement device 100 and other measurement devices described herein are not necessarily drawn to scale. The figures are intended to show how the features of the measurement devices can be arranged to create scanning patterns of light that are emitted from and scattered back to the measurement device 100.

The light source 110 can be a laser (e.g., laser diodes such as VCSELs and the like) or a light-emitting diode configured to emit coherent light. In certain embodiments, the light source 110 emits light (e.g., coherent light) within the infrared spectrum (e.g., 905 nm or 1515 nm frequencies) while in other embodiments the light source 110 emits light within the visible spectrum (e.g., as a 485 nm frequency). In certain embodiments, the light source 110 is configured to emit light in pulses.

The light emitted by the light source 110 is directed towards the plurality of disks. The emitted light and its direction are represented in FIG. 1 by arrows 120. In certain embodiments, the emitted light 120 is first directed towards the reflector 118, which reflects the light towards the plurality of disks. The reflector 118 can be a front surface mirror that is angled and positioned with respect to the light source 110 to reflect the emitted light 120 towards the plurality of disks. In FIG. 1, the direction of the emitted light 120 is modified by approximately 90 degrees, although other angles can be used depending on the orientation of the light source 110 with respect to the plurality of disks. In other embodiments, there are no intervening optical elements such as reflectors 118 between the light source 110 and the plurality of disks.

Each of the disks (the first disk 112A, the second disk 112B, and the third disk 112C) is configured to rotate independently of the other disks around a common axis 122. Each disk can be driven to rotate by a dedicated motor. FIG. 1 shows the measurement device 100 including a first motor 124A, a second motor 124B, and a third motor 124C. The first motor 124A is coupled to the first disk 112A via a first shaft 126A; the second motor 124B is coupled to the second disk 112B via a second shaft 126B; and the third motor 124C is coupled to the third disk 112C via a third shaft 126C. Each shaft can be coupled to respective disks at a central portion of the disk. For example, each disk can include a central aperture in which a respective shaft is positioned. In certain embodiments, the diameters of the shafts are different. For example, the first shaft 126A can have the largest diameter and the third shaft 126C can have the smallest diameter. The third shaft 126C can be sized such that it extends through an inner channel of the first shaft 126A and also through an inner channel of the second shaft 126B. Similarly, the second shaft 126B can be sized such that it can extend through the inner channel of the first shaft 126A. Thus, in some embodiments, the shafts 126A-C are coaxial shafts. In such arrangements, the disks can be rotated independently of each other. In other embodiments, a motor can be positioned within a central aperture of each disk. In other embodiments, motors can be positioned in between disks, supported by a central shaft.

In certain embodiments, the first disk 112A and the third disk 112C rotate in the same direction (e.g., clockwise) while the second disk 112B rotates in an opposite direction (e.g., counterclockwise). In certain embodiments, the first disk 112A and the second disk 112B rotate at substantially the same speed while the third disk 112C rotates at a different speed. For example, the first disk 112A and the second disk 112B may rotate at several thousand revolutions per minute (rpms) while the third disk 112C rotates at a thousand rpms or fewer. The rpms used during operation of the measurement device 100 can be selected based on the intended application. For example, increasing the rpm at which the first disk 112A and the second disk 112B rotate will increase the scan speed (e.g., frames per second) of the measurement device 100 but will also likely increase the power required by the motors to rotate the disks.

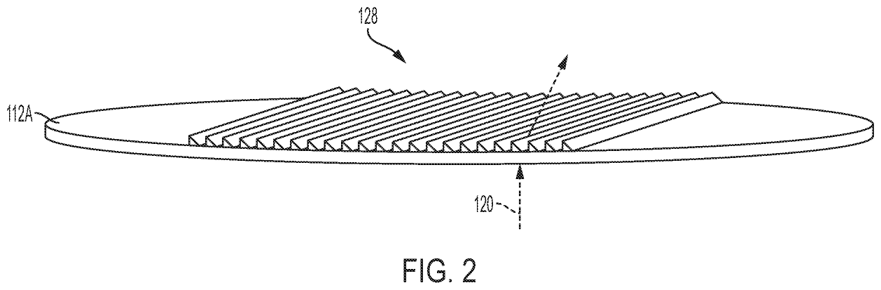

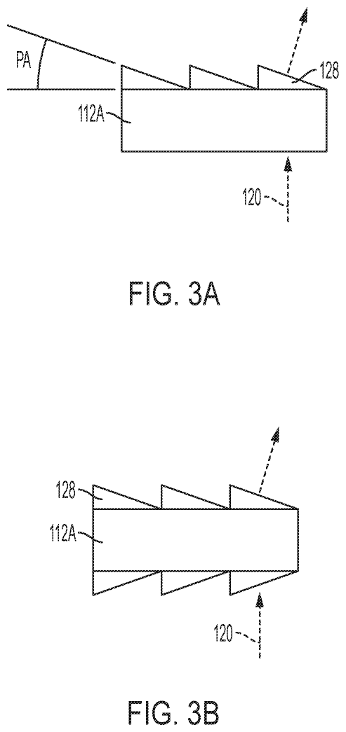

Each of the disks (the first disk 112A, the second disk 112B, and the third disk 112C) includes at least one set of prisms 128 (e.g., Fresnel prism). FIG. 2 shows a perspective view of the disk 112A with an example set of prisms 128, and FIGS. 3A and 3B show close-up side views of the prisms 128. Although FIG. 2 shows the prisms 128 only extending over a portion of one side of the disk 112A, the prisms 128 can extend over the entire upper and/or the entire lower surface of the disk 112A. FIGS. 3A and 3B show each of the prisms 128 having the same prism angle (PA). FIG. 3B also shows that the prisms 128 can be positioned on either or both sides of a disk 112A. Positioning the prisms 128 on both sides of the disk 112A can reduce sensitivity to internal reflection compared to the sensitivity associated with prisms 128 on a single side of the disk 112A. If prisms 128 are positioned on both sides of a disk, each set of prisms 128 can have a prism angle PA that is half the prism angle of that of a single-sided disk to bend the emitted light 120 the same angle as a single-sided disk. As described in more detail below, in certain embodiments, the first disk 112A and the second disk 112B each have a set of prisms 128 having substantially the same prism angle PA while the third disk 112C has prisms 128 with a prism angle PA that is different than the prism angle PA of the prisms on the first disk 112A and the second disk 112B.

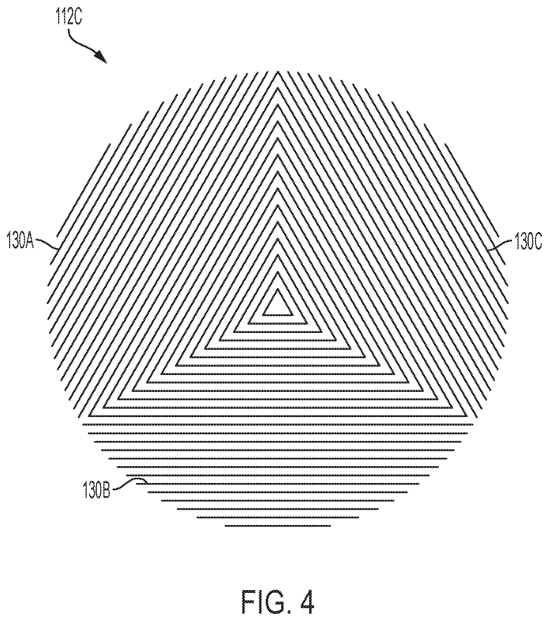

In certain embodiments, the third disk 112C includes multiple sets of prisms 128. For example, FIG. 4 shows a top view of the disk 112C with three different sets of prisms 130A, 130B, and 130C. Each set of prisms may have a different prism angle PA. In such embodiments, the measurement device 100 can have a light source 110 corresponding to each set of prisms 130A, 130B, and 130C or separate beams corresponding to each set of prisms 130A, 130B, and 130C. For example, when the third disk 112C includes three different sets of prisms 130A, 130B, and 130C, the measurement device 100 can have three light sources 110 or a single light source 110 that emits a beam, which is split into three separate beams before passing through the disks. Increasing the number of sets of prisms (and therefore beams) increases the number of scan lines and can therefore increase the pixel density of the light emitted from and scattered back to the measurement device 100.

In certain embodiments, the third disk 112C includes more than three different sets of prisms. For example, additional prisms can be used to adjust the sweep pattern of the light emitted from and scatted to the measurement device 100. In particular, five prisms can be used to increase how much the center of the field of view of the emitted laser beam pattern is sampled compared to edges of the field of view.

Each disk (the first disk 112A, the second disk 112B, and the third disk 112C) can be comprised of one or more transparent materials such as glass, sapphire, and polymers (e.g., polycarbonate, high-index plastics) and can be coated with an anti-reflective coating. In certain embodiments, gaps between prisms are filled with a polymer (e.g., a low index polymer) to reduce drag and turbulent flow between the disks. The disks and/or the prisms 128 can be made via molding, three-dimensional printing, etching, and the like. For example, each disk may be comprised of a planar disk substrate with the prisms 128 printed thereon. The diameter of the disks can vary depending on the application, size of the measurement device 100, and other constraints such as available power to rotate the disks. In certain embodiments, the disks are each 60-80 mm in diameter. Although the disks are shown as having a similar size, the disks can vary in size relative to each other. The disks can be positioned close to each other (e.g., on the order of 100 s of micrometers). The disks can be arranged in an order (e.g., the order at which the emitted light passes through the disks) other than the order shown in FIG. 1.

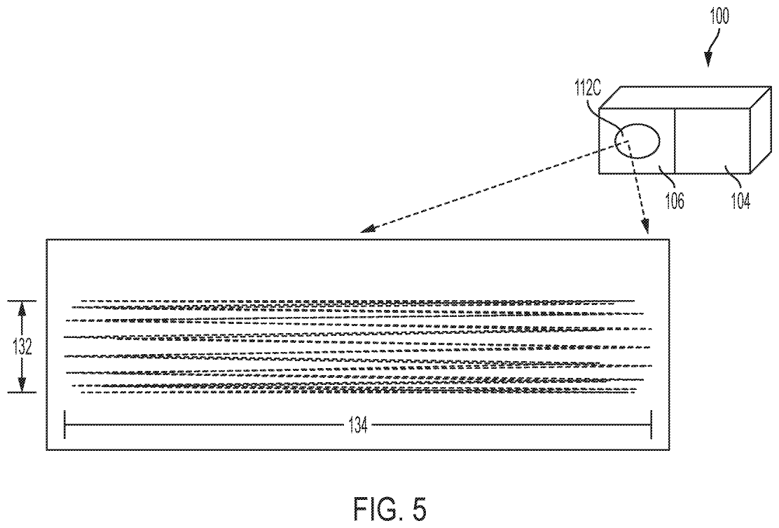

As will be described in more detail below, FIG. 5 shows an example light path 131 (e.g., scanning light pattern) that can be created by the measurement device 100 and other measurement devices described here. After the light emitted by the light source 110 passes through the rotating disks (and therefor prisms 128), the emitted light is directed along the path of the light pattern 131 in a raster-scan-like fashion.

The light pattern 131 has a vertical component 132 and a horizontal component 134 that makeup the field of view of the measurement device 100. Part of the horizontal component 134 (or displacement) portion of the light pattern 131 is created by the first disk 112A and the second disk 112B. When the first disk 112A and the second disk 112B rotate in opposite directions at the substantially the same speed, the two disks cause the emitted light to create a horizontal scan line. Put another way, the two counter-rotating disks steer the emitted light along a horizontal line. A horizontal scan line is created because the horizontal displacement of the light passing through the respective disks is in-phase while the vertical displacement of the light passing through the two disks is out-of-phase.

The extent of the horizontal component 134 is dependent on the prism angle PA of the prisms 128 on the first disk 112A and the second disk 112B. In one example, if the prism angle PA is 27.5 degrees for prisms 128 on both the first disk 112A and the second disk 112B, the horizontal displacement of the line is 110 degrees (i.e., 27.5 multiplied by 4) because each disk displaces the light at twice its prism angle PA. In certain embodiments, the range of prism angles PAs is 3-30 degrees.

A portion of the horizontal component 134 of the light pattern 131 and the vertical component 132 portion of the light pattern 131 is created by the third disk 112C. For example, if the prism angle PA of the prisms 128 on the third disk 112C is five degrees, the extent of horizontal component 134 of the light pattern is further increased by 10 degrees (i.e., 2 multiplied by 5) such that the total horizontal component 134 is 120 degrees from the three disks. The five-degree prism angle PA displaces (e.g., moves the line in a circle) the horizontal scan line a total of 10 degrees in the vertical direction. As such, the light emitted from the measurement device 100 creates the light pattern 131 shown in FIG. 5 with a field of view comprising the horizontal component 134 of 120 degrees and the vertical component 132 of 10 degrees.

In certain embodiments, the third disk 112C is rotated at an rpm that is an integer divisor of the rpm of the first disk 112A and the second disk 112B. In such embodiments, the emitted light is steered in a closed Lissajous curve, which is a more complex scanning pattern than a raster scan pattern. It has been found that such a pattern can lower the rpm of the first disk 112A and the second disk 112B required to accomplish a similar field of view and frame rate of a raster scan.

The emitted light is transmitted out of the housing 102 (e.g., through the translucent cover 106) of the measurement device 100 towards objects. A portion of the emitted light reflects off the objects and returns through the cover 106. This light, referred to as backscattered light, is represented in FIG. 1 by multiple arrows 130 (not all of which are associated with a reference number in FIG. 1). The backscattered light 130 passes through the plurality of rotating disks. After passing through the plurality of disks, the backscattered light 130 is focused by the focusing apparatus 114.

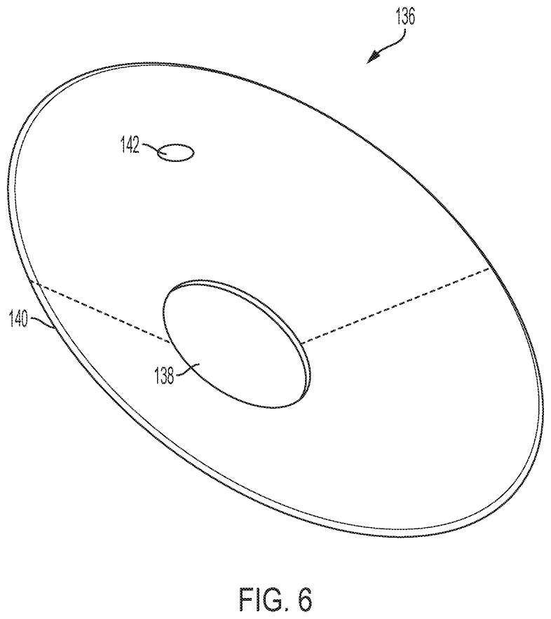

The focusing apparatus 114 is an optical element that focuses the backscattered light 130 towards the detector 116. For example, the focusing apparatus 114 can be a lens or a curved mirror such as a parabolic mirror. FIG. 1 shows the focusing apparatus 114 as a parabolic mirror with its focal point positioned at the detector 116. FIG. 6 shows a perspective view of a parabolic mirror 136 extending around a full 360 degrees with a central opening 138. In certain embodiments, the parabolic mirror 136 is arranged within the housing 102 such that one or more of the motors/shafts shown in FIG. 1 at least partially extend through the central opening 138. The dotted lines 140 in FIG. 6 show where the parabolic mirror 136 could be cut to create the shape of the focusing apparatus 114 shown in FIG. 1 which is less than the full 360 degrees of the parabolic mirror 136 shown in FIG. 6. The particular shape, size, position, and orientation of the focusing apparatus 114 in the measurement device 100 can depend on, among other things, the position of the detector(s) 116, where the path(s) at which backscattered light 130 is directed within the housing 102, and space constraints of the measurement device 100. As shown in FIGS. 1 and 6, the focusing apparatus 114 can include an aperture 142 to allow light emitted by the light source 110 to pass through the focusing apparatus 114.

In certain embodiments, the focusing apparatus 114 focuses backscattered light to a single detector 116, such as a photodetector/sensor. For example, the detector 116 can be positioned at the focal point of the focusing apparatus 114. In response to receiving the focused backscattered light, the detector 116 generates one or more sensing signals, which are ultimately used to detect the distance and/or shapes of objects that reflect the emitted light back towards the measurement device 100 and ultimately to the detector 116.

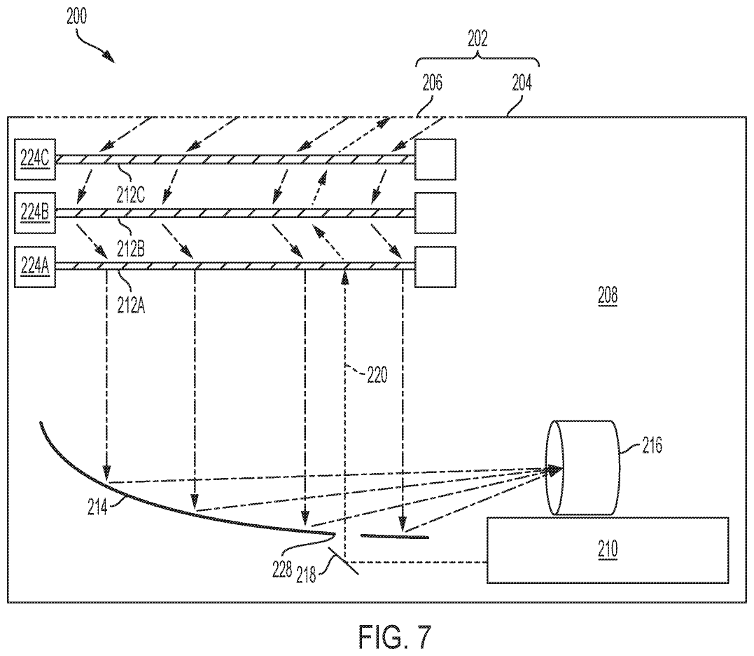

FIG. 7 shows a measurement device 200 that is similar to the measurement device 100 of FIG. 1. As will be described in more detail below, the measurement device 200 features a different arrangement of motors that rotate the plurality of disks compared to the arrangement of motors shown in FIG. 1. The various features described above with respect to the measurement device 100 of FIG. 1 can be incorporated into the measurement device 200.

The measurement device 200 includes a housing 202 with a base member 204 and a transparent cover 206 that can be coupled together to surround an internal cavity 208 in which various components of the measurement device 200 are positioned. For simplicity, the housing 202 in FIG. 7 is shown with only the base member 204 and the cover 206, but the housing 202 can comprise any number of components that can be assembled together to create the internal cavity 208 and secure components of the measurement device 200.

The measurement device 200 also includes a light source 210, a plurality of disks (e.g., a first disk 212A, a second disk 212B, and a third disk 212C), a focusing apparatus 214, and a detector 216. In certain embodiments, the measurement device 200 also includes one or more reflectors 218. As described above, the various features of the measurement device 200 can be substantially the same as the features described with respect to FIG. 1.

The light source 210 can be a laser or a light-emitting diode configured to emit coherent light. In certain embodiments, the light source 210 emits light within the infrared spectrum while in other embodiments the light source 110 emits light within the visible spectrum. In certain embodiments, the light source 210 is configured to emit light in pulses.

The light emitted by the light source 210 is directed towards the plurality of disks. The emitted light and its direction is represented in FIG. 7 by arrows 220. In certain embodiments, the emitted light 220 is first directed towards the reflector 218, which reflects the light towards the plurality of disks and which can be a front surface mirror that is angled. In other embodiments, there are no intervening optical elements such as reflectors 218 between the light source 210 and the plurality of disks.

Each of the disks (the first disk 212A, the second disk 212B, and the third disk 212C) is configured to rotate independently of the other disks around a common axis. Each disk can be driven to rotate by a dedicated motor. FIG. 7 shows the measurement device 200 including a first motor 224A, a second motor 224B, and a third motor 224C.

The first motor 224A is coupled to the first disk 212A at or near an outer circumference of the first disk 212A; the second motor 224B is coupled to the second disk 212B at or near an outer circumference of the second disk 212B; and the third motor 224C is coupled to the third disk 212C at or near an outer circumference of the third disk 212C. In some embodiments, the motors 224A-C can be ring-shaped or otherwise shaped so that the disks 212A-C are surrounded by the respective motors 224A-C. This arrangement does necessarily use multiple shafts like the measurement device 100 of FIG. 1. Further, there are fewer or no motor components potentially blocking light that passes through central portions of the disks 212A-C. The arrangement of motors 224A-C shown in FIG. 7 may also permit a more compact measurement device 200.

In certain embodiments, the first disk 212A and the third disk 212C rotate in the same direction (e.g., clockwise) while the second disk 212B rotates in an opposite direction (e.g., counterclockwise). In certain embodiments, the first disk 212A and the second disk 212B rotate at substantially the same speed while the third disk 212C rotates at a different speed.

Like the disks shown in FIGS. 2, 3A, and 3B, each of the disks (the first disk 212A, the second disk 212B, and the third disk 212C) includes at least one set of prisms having a prism angle and positioned on either or both sides of the disks. The first disk 212A and the second disk 212B each have a set of prisms having substantially the same prism angle while the third disk 212C has prisms with a prism angle that is different than the prism angle of the prisms on the first disk 212A and the second disk 212B. In certain embodiments, the third disk 212C includes multiple sets of prisms such as that shown in FIG. 4. The disks can be arranged in an order (e.g., the order at which the emitted light passes through the disks) other than the order shown in FIG. 7.

As the emitted light 220 travels through each set of the prisms, the prisms will bend the light at a fixed angle. The emitted light 220 is bent without focusing or diverging the light. When the first disk 212A and the second disk 212B rotate in opposite directions at the substantially the same speed, the two disks cause the emitted light to create a horizontal scan line. The third disk 212C displaces the horizontal scan line in the vertical direction to create a two-dimensional scan field of view.

The emitted light is transmitted out of the housing 202 (e.g., through the translucent cover 206) of the measurement device 200. The emitted light will reflect off objects, and a portion of that light will travel back through the cover 206. This light, referred to as backscattered light, is represented in FIG. 7 by multiple arrows 226. The backscattered light 226 passes through the plurality of rotating disks. After passing through the plurality of disks, the backscattered light 226 is focused by the focusing apparatus 214, such as the focusing apparatus 114 described above with respect to the measurement device 100 of FIG. 1. The particular shape, size, position, and orientation of the focusing apparatus 214 in the measurement device 100 can depend on, among other things, the position of the detector(s) 216, the path for the backscattered light 226 in the housing 202, and space constraints of the measurement device 200. As shown in FIG. 7, the focusing apparatus 214 can include an aperture 228 that allows light emitted by the light source 210 to pass through the focusing apparatus 214.

In certain embodiments, the focusing apparatus 214 focuses backscattered light to a single detector 216 (e.g., a photodetector/sensor). For example, the detector 216 can be positioned at the focal point of the focusing apparatus 214. In response to receiving the backscattered light, the detector 216 generates one or more sensing signals, which are ultimately used to detect the distance and/or shapes of objects that reflected the emitted light back towards the measurement device 200 and ultimately to the detector 216.

In embodiments described further below, measurement devices can create an improved two-dimensional field of view using a minimum of a single light source and two disks.

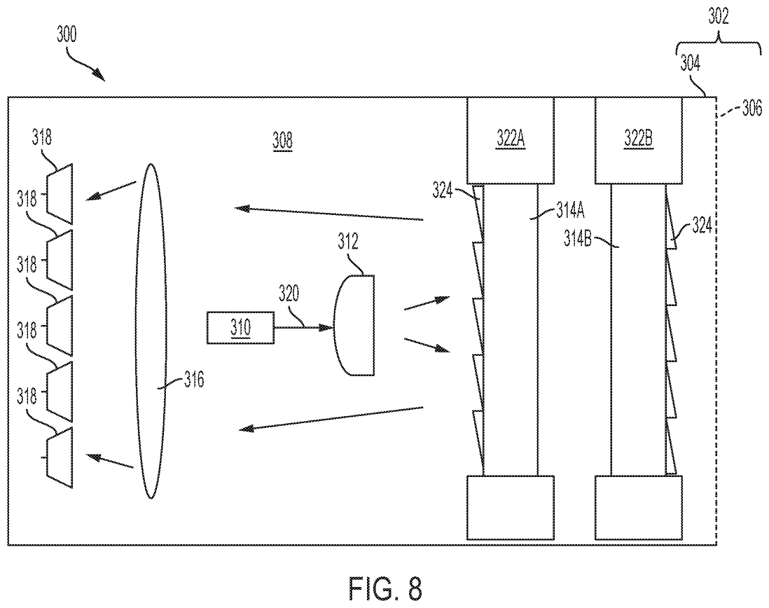

FIG. 8 shows a schematic of a measurement device 300 including a housing 302 with a base member 304 and a cover 306. The base member 304 and the cover 306 can be coupled together to surround an internal cavity 308 in which various components of the measurement device 300 are positioned. In certain embodiments, the base member 304 and the cover 306 are coupled together to create an air and/or water-tight seal. For example, various gaskets or other types of sealing members can be used to help create such seals between components of the housing 302. The base member 304 can comprise materials such as plastics and/or metals. The cover 306 can comprise transparent materials such as glass or sapphire. For simplicity, the housing 302 in FIG. 8 is shown with only the base member 304 and the cover 306, but the housing 302 can comprise any number of components that can be assembled together to create the internal cavity 308 and secure components of the measurement device 300.

The measurement device 300 includes a light source 310, a lens 312, a plurality of disks (e.g., a first disk 314A and a second disk 314B), a focusing apparatus 316, and a plurality of detectors 318.

The light source 310 can be a laser or a light-emitting diode configured to emit coherent light. In certain embodiments, the light source 310 emits light within the infrared spectrum while in other embodiments the light source 310 emits light within the visible spectrum. In certain embodiments, the light source 310 is configured to emit light in pulses.

The light emitted (e.g., a light beam) by the light source 310 is directed towards the lens 312 and is represented by arrows 320. In certain embodiments, the lens 312 is plano-convex lens that converts the light beam to a line. The lens 312 can comprise materials such as glass, sapphire, silicone, and the like. In certain embodiments, the lens 312 is arranged such that its convex side faces the light source 310 so light emitted 320 from the light source 310 passes through the convex side towards the plano side of the lens 312. In other embodiments, the lens 312 can be arranged such that the plano side of the lens 312 faces the light source 310.

The line of emitted light from the lens 312 is directed towards the plurality of disks (e.g., the first disk 314A and the second disk 314B). Each of the disks is configured to rotate independently of the other disks around a common axis. Each disk can be driven to rotate by a dedicated motor such as the motors described above with respect to FIGS. 1 and/or 7. FIG. 8 shows the first disk 314A coupled to a first motor 322A and the second disk 314B coupled to a second motor 322B. The first motor 322A and the second motor 322B are shown as being similar to the motors shown in FIG. 7 such that the motors 322A and 322B are coupled to the outer circumference of the respective disks 314A and 314B and, in some embodiments, surround the disks 314A and 314B.

The first disk 314A and the second disk 314B rotate in opposite directions from each other at substantially the same speed. The first disk 314A and the second disk 3148 include at least one set of prisms 324. The prisms 324 shown in FIG. 8 are enlarged to show the orientation and general shape of the prisms 324. Each of the prisms 324 have substantially the same prism angle.

The horizontal displacement of the light after having passed through the two rotating disks is dependent on the prism angle of the prisms 324 on the first disk 312A and the second disk 312B. In one example, if the prism angle is 30 degrees for prisms 324 on both the first disk 312A and the second disk 312B, the horizontal displacement of the line is 120 degrees (i.e., 30 multiplied by four) because each disk displaces the light by twice its prism angle. The vertical displacement is dependent on the shape of the lens 312.

The emitted light 320 is transmitted out of the housing 302 (e.g., through the translucent cover 306) towards objects. A portion of the emitted light reflects off the objects and returns through the cover 306. This light, referred to as backscattered light, passes through the plurality of rotating disks. After passing through the plurality of disks, the backscattered light is focused by the focusing apparatus 316. The focusing apparatus 316 is an optical element (e.g., lens) that focuses the backscattered light towards the plurality of detectors 318, which can be photodetectors/sensors.

In response to the backscattered light, the detector 316 generates one or more sensing signals, which are ultimately used to detect the distance and/or shapes of objects that reflect the emitted light back towards the measurement device 300.

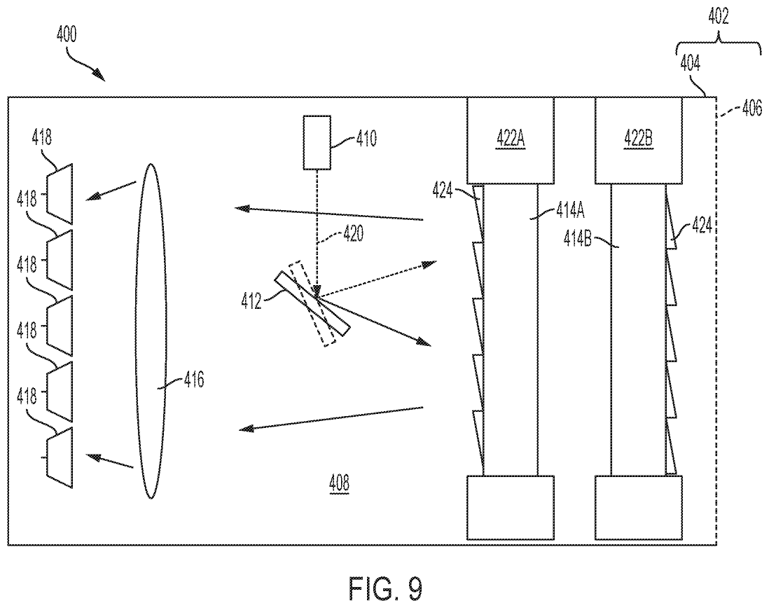

FIG. 9 shows a schematic of a measurement device 400 including a housing 402 with a base member 404 and a cover 406. The base member 404 and the cover 406 can be coupled together to surround an internal cavity 408 in which various components of the measurement device 400 are positioned. In certain embodiments, the base member 404 and the cover 406 are coupled together to create an air and/or water-tight seal. For example, various gaskets or other types of sealing members can be used to help create such seals between components of the housing 402. The base member 404 can comprise materials such as plastics and/or metals. The cover 406 can comprise transparent materials such as glass or sapphire. For simplicity, the housing 402 in FIG. 9 is shown with only the base member 404 and the cover 406, but the housing 402 can comprise any number of components that can be assembled together to create the internal cavity 408 and secure components of the measurement device 400.

The measurement device 400 includes a light source 410, a rotatable mirror 412, a plurality of disks (e.g., a first disk 414A and a second disk 414B), a focusing apparatus 416, and a plurality of detectors 418.

The light source 410 can be a laser or a light-emitting diode configured to emit coherent light. In certain embodiments, the light source 410 emits light within the infrared spectrum while in other embodiments the light source 310 emits light within the visible spectrum. In certain embodiments, the light source 410 is configured to emit light in pulses.

The light emitted by the light source 410 is directed towards the rotatable mirror 412 and is represented by arrows 420. The rotatable mirror 412 can reflect the emitted light to create a line of emitted light. As indicated by dotted lines in FIG. 9, the rotatable mirror 412 can rotate between positions to create the line. In certain embodiments, the rotatable mirror 412 is a silicon-based MEMS mirror.

The line of emitted light from the rotatable mirror 412 is directed towards the plurality of disks (e.g., the first disk 414A and the second disk 414B). Each of the disks is configured to rotate independently of the other disks around a common axis. Each disk can be driven to rotate by a dedicated motor such as the motors described above with respect to FIGS. 1 and/or 6. FIG. 9 shows the first disk 414A coupled to a first motor 422A and the second disk 414B coupled to a second motor 422B. The first motor 422A and the second motor 422B are shown as being similar to the motors shown in FIG. 7 such that the motors 422A and 422B are coupled to the outer circumference of the respective disks 414A and 414B and, in some embodiments, surround the disks 414A and 414B.

The first disk 414A and the second disk 414B rotate in opposite directions from each other at substantially the same speed. The first disk 414A and the second disk 4148 include at least one set of prisms 424. The prisms 424 shown in FIG. 9 are enlarged to show the orientation and general shape of the prisms 424. Each of the prisms 424 have substantially the same prism angle. The prisms 424 can be positioned on either or both sides of a disk as shown in FIGS. 3A and 3B.

The horizontal displacement of the light after having passed through the two rotating disks is dependent on the prism angle of the prisms 424 on the first disk 412A and the second disk 412B. In one example, if the prism angle is 30 degrees for prisms 424 on both the first disk 412A and the second disk 412B, the horizontal displacement of the line is 120 degrees (i.e., 30 multiplied by four). The vertical displacement is created by rotating the rotatable mirror 412.

The emitted light 420 is transmitted out of the housing 402 (e.g., through the translucent cover 406) towards objects. A portion of the emitted light reflects off the objects and returns through the cover 406. This light, referred to as backscattered light, passes through the plurality of rotating disks. After passing through the plurality of disks, the backscattered light is focused by the focusing apparatus 416. The focusing apparatus 416 is an optical element (e.g., lens) that focuses the backscattered light towards the plurality of detectors 418, which can be photodetectors/sensors.

In response to the backscattered light, the detector 416 generates one or more sensing signals, which are ultimately used to detect the distance and/or shapes of objects that reflect the emitted light back towards the measurement device 400 and the detector 416.

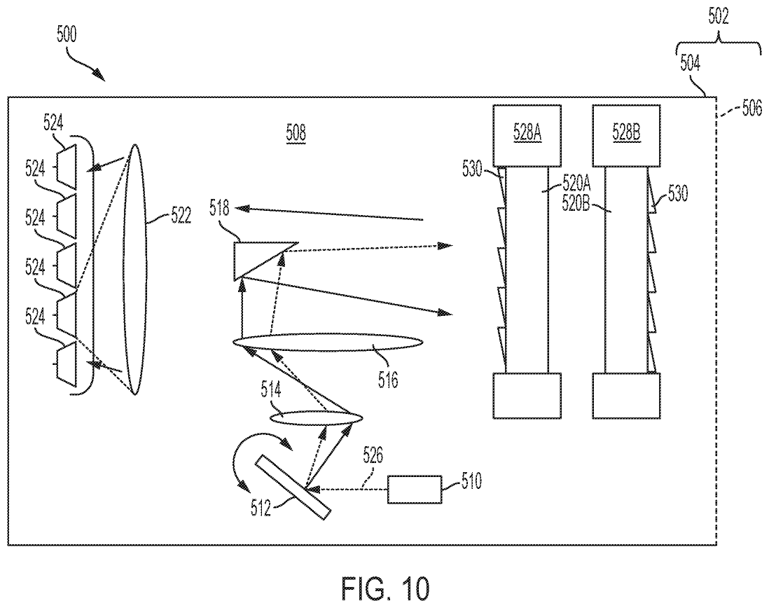

FIG. 10 shows a schematic of a measurement device 500 including a housing 502 with a base member 504 and a cover 506. The base member 504 and the cover 506 can be coupled together to surround an internal cavity 508 in which various components of the measurement device 500 are positioned. In certain embodiments, the base member 504 and the cover 506 are coupled together to create an air and/or water-tight seal. For example, various gaskets or other types of sealing members can be used to help create such seals between components of the housing 502. The base member 504 can comprise materials such as plastics and/or metals. The cover 506 can comprise transparent materials such as glass or sapphire. For simplicity, the housing 502 in FIG. 10 is shown with only the base member 504 and the cover 506, but the housing 502 can comprise any number of components that can be assembled together to create the internal cavity 508 and secure components of the measurement device 500.

The measurement device 500 also includes a light source 510, a rotatable mirror 512, a first lens 514, a second lens 516, a mirror 518, a plurality of disks (e.g., a first disk 520A and a second disk 520B), a focusing apparatus 522, and a plurality of detectors 524.

The light source 510 can be a laser or a light-emitting diode configured to emit coherent light. In certain embodiments, the light source 510 emits light within the infrared spectrum while in other embodiments the light source 510 emits light within the visible spectrum. In certain embodiments, the light source 510 is configured to emit light in pulses.

The light emitted by the light source 510 is directed towards the rotatable mirror 512 and is represented by arrows 526. The first rotatable mirror 512 can reflect the emitted light 526 to create a scanning line of emitted light by rotating between positions. In certain embodiments, the rotatable mirror 512 is a silicon-based MEMS mirror.

The line of emitted light reflected by the rotatable mirror 512 is directed towards the first lens 514, which magnifies the emitted light, which is then directed towards the second lens 516. The second lens 516 collimates the magnified light, which is then directed towards the mirror 518. The mirror 518 can be a front surface mirror that is angled and positioned to reflect the emitted light towards the plurality of disks (e.g., the first disk 520A and the second disk 520B). The mirror 518 can positioned within the measurement device 500 at the focal point of the first lens 514 and the second lens 516.

Each of the disks is configured to rotate independently of the other disks around a common axis. Each disk can be driven to rotate by a dedicated motor such as the motors described above with respect to FIGS. 1 and 7. FIG. 10 shows the first disk 520A coupled to a first motor 528A and the second disk 520B coupled to a second motor 528B. The first motor 528A and the second motor 528B are shown as being similar to the motors shown in FIG. 7 such that the motors 528A and 528B are coupled to the outer circumference of the respective disks 520A and 520B and, in some embodiments, surround the disks 520A and 520B.

The first disk 520A and the second disk 520B rotate in opposite directions from each other at substantially the same speed. The first disk 520A and the second disk 520B include at least one set of prisms 530. The prisms 530 shown in FIG. 10 are enlarged to show the orientation and general shape of the prisms 530. Each of the prisms 530 have substantially the same prism angle. The prisms 530 can be positioned on either or both sides of a disk as shown in FIGS. 3A and 3B.

The horizontal displacement of the light after having passed through the two rotating disks is dependent on the prism angle of the prisms 530 on the first disk 520A and the second disk 520B. In one example, if the prism angle is 30 degrees for prisms 530 on both the first disk 520A and the second disk 520B, the horizontal displacement of the line is 120 degrees (i.e., 30 multiplied by four). The vertical displacement is dependent on the extent of rotation of the rotatable mirror 512.

The emitted light is transmitted out of the housing 502 (e.g., through the translucent cover 506) towards objects. A portion of the emitted light reflects off the objects and returns through the cover 506. This light, referred to as backscattered light, passes through the plurality of rotating disks. After passing through the plurality of disks, the backscattered light is focused by the focusing apparatus 516. The focusing apparatus 516 is an optical element (e.g., lens) that focuses the backscattered light towards the plurality of detectors 518, which can be photodetectors/sensors.

In response to the backscattered light, the detector 516 generates one or more sensing signals, which are ultimately used to detect the distance and/or shapes of objects that reflect the emitted light back towards the measurement device 500.

In certain embodiments, the measurement devices described above are incorporated into measurement systems such that the systems include one or more measurement devices. For example, a measurement system for an automobile may include multiple measurement devices, each installed at different positions on the automobile to generate scanning light patterns and detect backscattered light in a particular direction of the automobile. Each measurement device may include circuitry for processing the detected backscattered light and generating signals indicative of the detected backscattered light, which may be used by measurement systems to determine information about objects in the measurement devices' fields of view.

Various methods can be carried out in connection with the measurement devices described above. As one example, a method for generating a scanning light pattern using the measurements devices 100, 200 of FIGS. 1 and 7 includes rotating the first disk 112A in a first direction at a first speed, rotating the second disk 112B in a second direction at the first speed, and rotating the third disk 112C in the first direction at a second speed. The method further includes directing light from the light source 110 through the first disk 112A, the second disk 112B, and the third disk 112C to generate the scanning light pattern described above and schematically shown in FIG. 5. Components of the other measurement devices described herein can be used in various methods to generate scanning light patterns and detect backscattered light from the scanning light patterns.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. An apparatus comprising:
a detector;
a light source configured to emit light;
a plurality of disks, each disk having a set of prisms, each disk being independently rotatable, arranged to receive the emitted light directly or indirectly from the light source, and arranged to receive backscattered light from an object; and
a focusing apparatus arranged to focus the backscattered light from the plurality of disks towards the detector.

2. The apparatus of claim 1, further comprising:
a housing including a base member and a transparent cover that at least partially encompass an internal cavity,
wherein the detector, the light source, the plurality of disks, and the focusing apparatus are positioned within the internal cavity.

3. The apparatus of claim 1, wherein the plurality of disks includes a first disk, a second disk, and a third disk, wherein the first disk and the second disk are configured to rotate in the same direction and the third disk is configured to rotate in an opposite direction of the first disk and the second disk.

4. The apparatus of claim 3, wherein the first disk and the third disk rotate at substantially the same speed.

5. The apparatus of claim 1, wherein the plurality of disks includes a first disk and a second disk, wherein the first disk and the second disk are configured to rotate in opposite directions, the apparatus further comprising:
a first motor arranged to rotate the first disk; and
a second motor arranged to rotate the second disk.

6. The apparatus of claim 1, wherein the plurality of disks includes a first disk and a second disk, wherein the first disk and the second disk have prisms of substantially the same prism angle.

7. The apparatus of claim 6, wherein the plurality of disks further includes a third disk, wherein the third disk includes prisms having a prism angle different than the prism angle of the first disk and the second disk.

8. The apparatus of claim 6, wherein the plurality of disks further includes a third disk, wherein the third disk includes multiple patterns of prisms.

9. The apparatus of claim 1, wherein the focusing apparatus is a curved mirror.

10. The apparatus of claim 1, wherein the focusing apparatus includes an aperture through which the emitted light passes.

11. The apparatus of claim 1, wherein the detector is a single detector.

12. The apparatus of claim 1, further comprising:
a reflector arranged to reflect light from the light source towards the plurality of disks.

13. The apparatus of claim 12, wherein the reflector is a rotatable mirror.

14. The apparatus of claim 13, further comprising:
a lens arranged between the plurality of disks and the detector, wherein the detector includes a plurality of detectors.

15. The apparatus of claim 13, further comprising:
a plurality of lenses arranged between the light source and the plurality of disks; and
a receiving lens arranged between the plurality of disks and the detector, wherein the detector includes a plurality of detectors.

16. The apparatus of claim 15, further comprising:
a flat surface mirror positioned along an optical path between the rotatable mirror and the plurality of disks.

17. A method for generating a scanning light pattern, the method comprising:
rotating a first disk in a first direction at a first speed, the first disk having prisms with a first prism angle;
rotating a second disk in a second direction at the first speed, the second disk having prisms with the first prism angle;
rotating a third disk in the first direction at a second speed, the third disk having prisms with a second prism angle; and
directing light from a light source through the first disk, the second disk, and the third disk to generate the scanning light pattern.

18. The method of claim 17, further comprising:
receiving, at a detector, backscattered light of the generated scanning light pattern that passes through the first disk, the second disk, and the third disk.

19. The method of claim 17, further comprising:
focusing, with a focusing apparatus, the backscattered light towards the detector.

20. A system for generating a scanning light pattern, the system comprising:
a first disk configured to rotate in a first direction at a first speed and including prisms with a first prism angle;
a second disk configured to rotate in a second direction at the first speed and including prisms with the first prism angle;
a third disk configured to rotate in the first direction at a second speed and including prisms with a second prism angle; and
a light source configured to emit light such that the emitted light passes through the first disk, the second disk, and the third disk.
